(19) United States
(12) Patent Application Publication
(10) Pub. No.: US 2015/0157531 A1
(43) Pub. Date: Jun. 11, 2015

(54) SEXUAL INTERCOURSE MASSAGE DEVICE

(71) Applicant: Filip Sedic, Shanghai (CN)

(72) Inventor: Filip Sedic, Shanghai (CN)

(21) Appl. No.: 14/562,587

(22) Filed: Dec. 5, 2014

(30) Foreign Application Priority Data
Dec. 9, 2013 (CN) 201320801219.2

(51) Int. Cl. A61H 23/00; A61H 19/00

(52) U.S. Cl. CPC A61H 23/00; A61H 19/40; A61H 19/34

(57) ABSTRACT

A sexual intercourse massage device for use by couples includes a body and a male genital projection. The male genital projection is coupled to the body of the massager and extends from the body of the massager. The body of the massager includes a circular hole and a vibrating motor. The circular hole has certain elasticity and can be secured onto the penis of a user, working to augment the volume of the penis. The male genital projection resembles a male genital in an erect condition extending from the body of the massager. The male genital projection is configured for insertion into an orifice of a sexual partner, and can provide vibrations to the user and the partner during intercourse.

### CROSS REFERENCE TO RELATED APPLICATIONS

This application claims the benefit of Chinese Application No. 201320801219.2, filed Dec. 9, 2013, which is incorporated by reference in its entirety. This application is related to U.S. application Ser. No. 29/490,352, filed May 9, 2014, and U.S. application Ser. No. 29/503,263, filed Sep. 24, 2014, each of which are incorporated by reference in their entirety.

### BACKGROUND

The present invention relates generally to personal massagers, and more particularly to massage devices for use by couples during sexual intercourse.

Sexual intercourse devices have been developed in a variety of shapes and sizes to aid in improving the sexual experience of users. Certain sexual aids developed specifically for use or wear by males are limited in the sexual benefit provided to partners, thus limiting the experience of the partners during sex. In extreme circumstances, sexual partners can develop sexual indifference or dysfunction as a result of a sub-optimal sexual experience. Thus, there is a need for a sexual intercourse massage device that provides a sexual benefit to both a male wearing the device and a sexual partner.

### SUMMARY

Embodiments include a sexual intercourse massage device for use during sexual intercourse, the massager device including a body and a male genital projection. The male genital projection is coupled to the body of the massager and extends from the body of the massager. The body of the massager includes a circular hole and a vibrating motor. The structure of the massager allows for a male user to inset his penis into the circular hole, thereby coupling the massager to the penis. The circular hole has certain elasticity and can be secured onto the penis of a user and works to augment the volume and rigidity of the penis. The male genital projection is configured for insertion into the vagina of a female user and can be in contact with or near an area between the entry of the vagina and the region near the clitoris. The massager may also include additional features, such as an interface button and a power connector interface. The button can be an on/off switch for powering the massager on and off, or can be used to configure the massager into one or more operating modes. The power connector interface allows for recharging the power source of the massager in a non-operating mode.

### BRIEF DESCRIPTION OF THE DRAWINGS

FIGS. 1A, 1B, and 1C collectively illustrate an example of a sexual intercourse massage device for couples, according to one embodiment.

FIG. 1D and 1E illustrate an example of the sexual intercourse massage device without the male genital projection, according to one embodiment.

FIG. 2 is a block diagram of components of a sexual intercourse massage device for couples, according to one embodiment.

FIG. 3 is an exploded diagram of the body of the sexual intercourse massage device for couples, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Wearable Massager for Couples

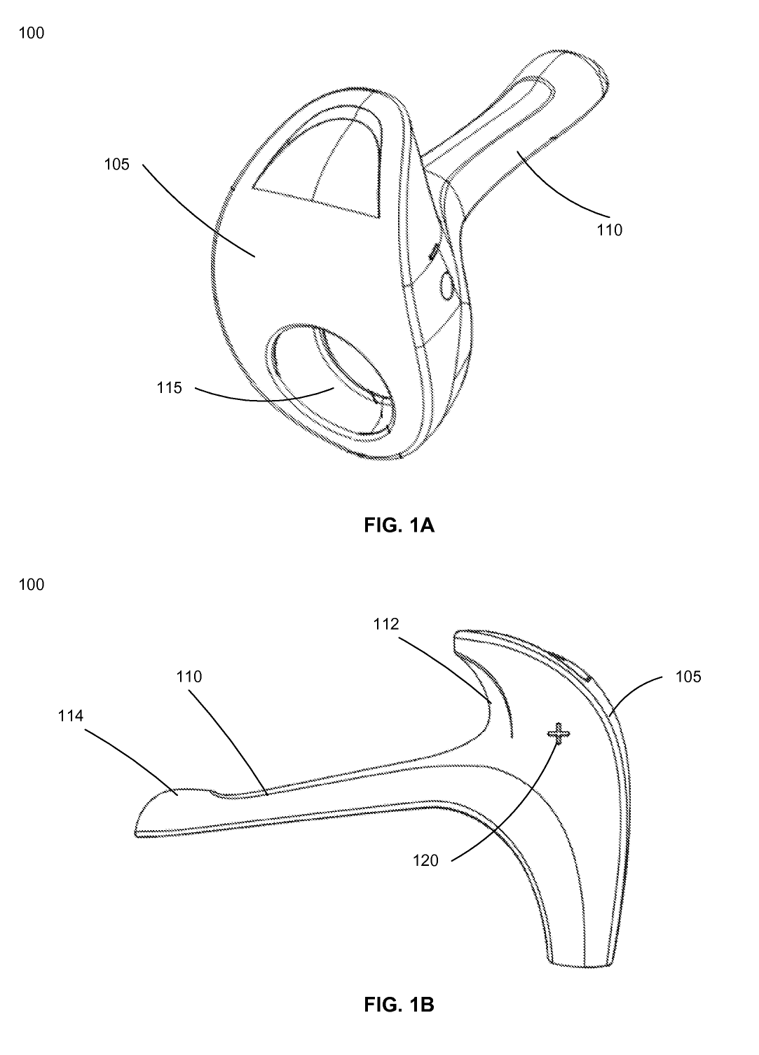

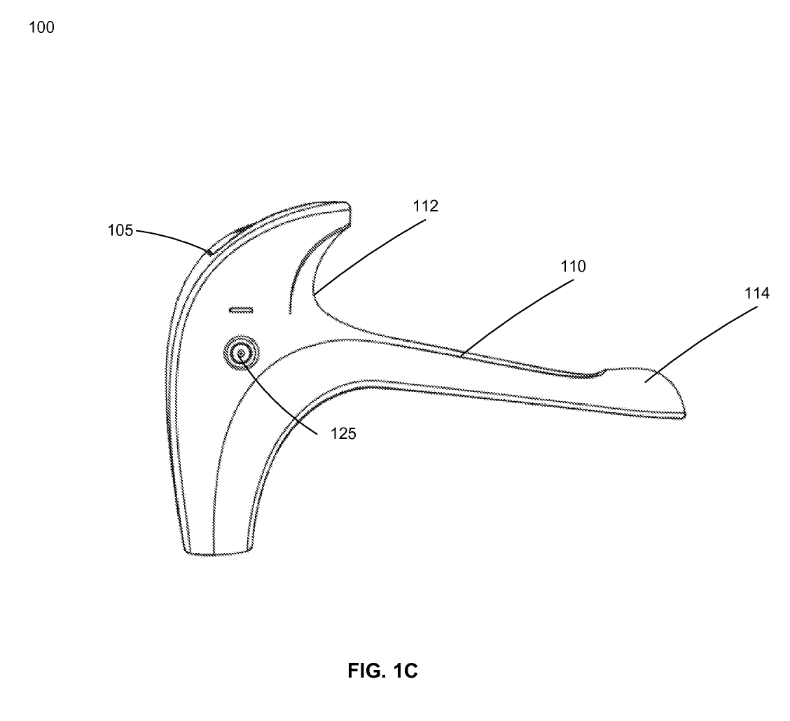

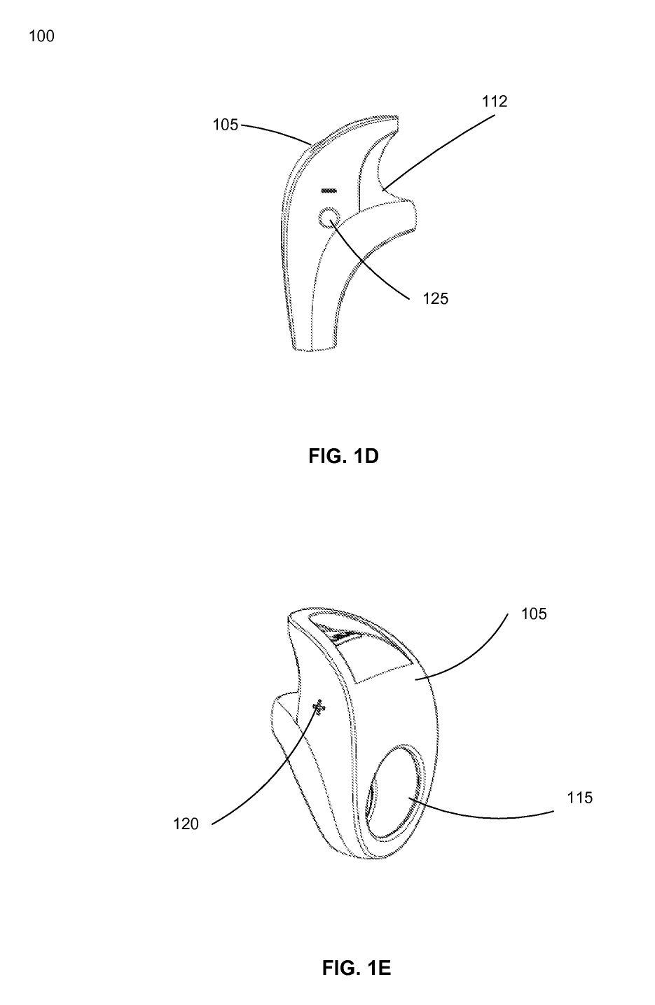

FIGS. 1A, 1B, and 1C collectively illustrate an example of a sexual intercourse massage device 100 for couples, according to one embodiment. FIG. 1A illustrates a perspective view of the massager 100. FIGS. 1B and 1C illustrate side views of the massager 100. The massager 100 includes a body 105 and a male genital projection 110 coupled to the body 105 and extending outward from the body 105. The body 105 includes a vibrating motor and a circular hole 115 located in the lower portion of the body 105, below the projection 110. In other embodiments, the massager 100 can include additional and/or different components to perform the functions as described.

The body 105 can be made of silica gel or other suitable material allowing it to be soft, elastic, and durable. The material used in the exterior of the massager 100 can be selected from materials known to be non-reactive to human skin, beneficially decreasing the safety risks of an allergic reaction while using the massager. In some embodiments, the massager 100 can be made of a water-resistant material, and can be waterproof. In some embodiments, the massager 100 can be made of a material with a below threshold coefficient of friction, reducing the friction force created during use between the massager 100 and a surface of a user's partner.

The massager 100 is structured such that the circular hole 115 in the body 105 of the massager 100 has certain elasticity and can be secured onto the penis of a user. It should be noted that although a hole 115 within the body 105 of the massager 100 is illustrated herein, in other embodiments, the massager 100 can couple to a penis by other means, such as a strap, an elastic band, and the like. When the massager 100 is worn by a male user, the projection 110 abuts and extends along a top surface of the user of the user, augmenting the volume and rigidity of the penis. In some embodiments, the projection beneficially blocks contact between a portion of the user's penis (the top surface) and a sexual partner, reducing the sexual friction experienced by the user, and thereby extending the sexual duration of the user. The projection 110 also acts to enlarge the penis of the user, beneficially increasing the girth felt by a partner during intercourse. As illustrated in FIGS. 1A-1C, the male genital projection 110 resembles an erect penis, though it should be emphasized that in other embodiments, the projection 110 can take any shape or orientation such that at least a portion of the projection abuts a user's penis. In use, the male genital projection 110 and a user's penis together can be inserted into the vagina of a female user such that the massager 100 makes contact with one or both of a female user's clitoris and Grafenberg spot (“G-spot” hereinafter). As described herein, the massager 100 can vibrate in various locations, thereby massaging and/or stimulating one or both of a female partner's clitoris and G-spot.

The massager 100 is configured to be worn by a male user during sexual intercourse with a partner. It should be noted that reference to a female partner is made herein for the purposes of simplicity, though the massager 100 may be worn by a male user during intercourse with another male user. While the massager 100 is being worn by a male user, the projection 110 and the penis of the male user are inserted into an opening (e.g., the vagina) of the female user, allowing the male and the female to proceed with sexual intercourse.

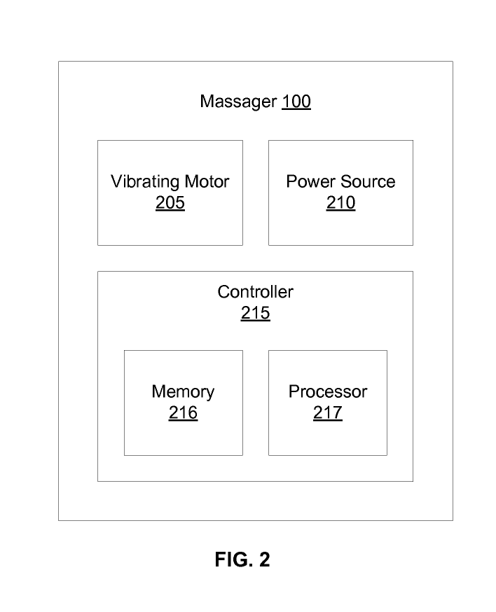

The body 105 of the massager 100 can include a vibrating motor configured to cause the body 105 and one or more surfaces of the massager 100 to vibrate during use as is further described in conjunction with FIG. 2 below. In some embodiments, a first, curved surface 112 abutting the clitoris of a partner during use is configured to vibrate, thereby stimulating the clitoris. In some embodiments, a second, protruding surface 114 located at the end of the protrusion 110 and abutting the G-spot of a partner during use is configured to vibrate, thereby stimulating the G-spot. Beneficially, the vibration of the massager 110 during use can be experienced by both a male wearer and a female partner, providing simultaneous sexual benefit to both partners. For instance, the vibrations transmitted along the projection 110 can stimulate both the frenulum nerve of the male user's penis and the clitoris, G-spot, and other portions of the vagina of the female user.

As noted above, the width and shape of the male genital projection 110 can vary. For example, the width of the male genital projection 110 can be uniform along the length of the projection 110. The male genital projection 110 can include a tapered curved surface at the end of the projection to create a rounded projection end as opposed to an abrupt or edged projection end. Further, in some embodiments, the texture of the male genital projection 110 may vary across the length of the projection 110. For instance, portions of the projection (such as the top surface, the bottom surface, or both) can include ribs or ridges configured to provide additional sexual stimulation. It should be noted that in some embodiments, the projection 110 does not extend along the entire length of a penis, and instead only extends along a portion of the length of the penis. In other embodiments, the projection 110 does not protrude very far from the body 105 at all, for instance 1 inch or less. Yet other embodiments do not include a projection at all.

In one embodiment, the body 105 and the male genital projection 110 are configured to vibrate in one of one or more operating modes. For instance, in a first operating mode, the body 105 and projection 110 can vibrate at a first rate, and in a second operating mode, the body 105 and projection 110 can vibrate at a second, different rate. In some operating modes, either one or the other of the body 105 and projection 110 vibrate. In yet other operating modes, the body 105 vibrates at a first rate while the projection 110 vibrates at a second rate. In some operating modes, one or both of the body 105 and the projection 110 vibrate in one of a plurality of pulse patterns. In such operating modes, the intensity of vibrating of one or both of the body 105 and the projection can vary. In various embodiments, the operating mode can be selected by a user of the massager 100. For example, the user can select the operating mode using a remote controller, smart device (such as a mobile phone, computer, or other device), or any other suitable device that is wirelessly coupled to the massager 100. In one embodiment, the remote controller is the remote controller described in U.S. patent application Ser. No. 13/492,909, filed on Jun. 10, 2012, which is hereby incorporated by reference in its entirety.

The massager 100 may also include additional features, such as a button 120 and a power connector interface 125. The button 120 can be an on/off switch for powering the massager 100 on and off. In addition, the button 120 can also activate wireless pairing of the massager 100 to a remote controller or smart device used to operate the massager 100. The button 120 may also be used to select an operating mode of the massager 100 during use. For example, a user can select an operating mode of the massage 100 by pressing the button 120 a number of times correlating to a desired operating mode. The various modes of operation can include different combinations of patterns, speeds, or intensities of vibrations, durations of vibrations, or any other suitable massaging motions. In some embodiments, the various modes of massage or operation can vary based on motion-sensing, as described in U.S. patent application Ser. No. 13/492,909, filed on Jun. 10, 2012, the contents of which are hereby incorporated in their entirety. In another embodiment, the remote controller comprises a motion sensor and the massager 100 operates responsive to the motion sensed by the remote controller. It should be noted that in other embodiments, the massager 100 can include a different number or configuration of buttons, each configured to perform one or more functions described herein or additional functions not described herein, and/or can include one or more other interface options than those illustrated herein (such as one or more switches, touch sensors, and the like).

The massager 100 includes a battery or other power source configured to provide power to the electronic components of the massager 100 (such as the vibrating motor, the communicative interfaces, and a controller or processor configured to operating the massager 100). The power connector interface 125 allows for recharging the power source of the massager 100. For instance, the power connector interface 125 can allow for the insertion of a power cable coupled to a power supply to allow a user to electrically couple the massager 100 to the power supply, allowing the massager 100 to draw power from the power supply to recharge the power source of the massager.

The massager 100 can also include an indicator to indicate one or more states of the massager 100 to a user of the massager 100. For example, the indicator can indicate a power level of a power source within the massager 100. In some embodiments, the indicator can include a number of light segments corresponding to various power levels, and can illuminate a number of the light segments corresponding to a current power level of the power source of the massager 100. Likewise, the indicator can display a percentage number illustrating a percentage of total power remaining within the power source of the massager 100.

In some embodiments, the indicator can also indicate an operating mode of the massager 100 during use. For instance, the indicator can display a number corresponding to an operating mode, text describing or associated with an operating mode, and the like. In some embodiments, the indicator can display a representation of the intensity of vibration of the massager 100, a pattern of vibration, and the like. The indicator can include various display components, such as an LCD or LED display, LED lights, displayed text or symbols, and the like.

FIG. 1D and 1E illustrate an example of the sexual intercourse massage device 100 without the male genital projection 110, according to one embodiment. FIG. 1E illustrates a perspective view of the massager 100 without the male genital projection 110. FIG. 1D illustrates a side view of the massager 100 without the male genital projection 110. In the example of FIG. 1D, the massager 100 includes the body 105, the first curved surface 112 that abuts the clitoris of a partner during use and is configured to vibrate, thereby stimulating the clitoris, and the power connecting interface 125. In the example of FIG. 1E, the massager 100 includes the body 105, the circular hole 115 in the body 105, and the button for powering the massager 100 on and off. The massager 100, as described in FIGS. 1D and 1E operates substantially similarly to the massager described in conjunction with FIGS. 1A, 1B, and 1C.

FIG. 2 is a block diagram of components of a sexual intercourse massage device for couples, according to one embodiment. FIG. 2 provides an example of some of the components that might be included in the massager 100 in one embodiment, though other embodiments may include different components than those illustrated herein. The massager 100 shown in FIG. 2 includes a vibrating motor 205, a power source 210, and a controller 215. The controller 215 controls the operating mode of the massager 100 using the motor 205 and using power from the power source 210. In addition, the massager 100 can include sensors not illustrated herein, such as a motion sensor.

The vibrating motor 205 is integrated in the massager 100 and configured such that the motor vibrates the body 105 of the massager 100 using, for example, off-center weights located on an axis within the vibrating motor 205. In addition, the vibrating motor 205 is also configured to provide vibrations within one or more portions of male genital projection 110. It should be noted that in some embodiments, the vibrating motor 205 vibrates the projection 110 by rotating an off-center weighted protrusion extending within the projection 110. The motor 205 can be an electric or an electromagnetic motor, such as an AC motor, a DC motor, or any other suitable motor or mechanism that converts electricity into a mechanical motion.

The power source 210 is electrically coupled to the vibrating motor 205 and the controller 215, and provides electrical power to the vibrating motor 205 and the controller 215. The power source 210 can include one or more batteries, such as lithium-ion batteries, capacitors, or any other suitable power source. The power source 210 is electrically coupled to the power connecting interface 125, and is configured to receive power from an external power supply via the power connecting interface 125 to allow for charging the power source 210.

The controller 215 includes memory 216 and a processor 217, and is communicatively coupled to the vibrating motor 205. The controller 215 stores one or more operating modes within the memory 216 as computer-executable instructions, each associated with a setting of one or more of vibrations, duration of vibrations, speed of vibrations, intensity of vibrations, and the like. The controller 215 implements one or more of the operating modes based on a selected operating mode, for instance by a user of the massager 100, through the massager 100 or remote controller. To implement an operating mode, the processor 217 accesses an operating mode stored in the memory 216, and executes the computer-executable instructions associated with the operating mode. In response, the executed instructions cause the vibrating motor 205 to implement vibrations associated with the operating mode. The massaging patterns of the massager's 100 operating mode can vary in strength and duration. In one example, the body 105 of the massager 100 pulsatingly vibrates for a first duration of time and vibrates at a faster rate for a second duration of time.

In one embodiment, the massager 100 can include one or more motion sensors. Based on changes in the x-, y-, or z-axis, as detected by the one or more motion sensors, the mode of the massager 100 can vary. In addition, the remote controller can include the one or more motion sensors and vary the mode of the massager 100 based on the detected changes in the x-, y-, or z-axis of the remote controller.

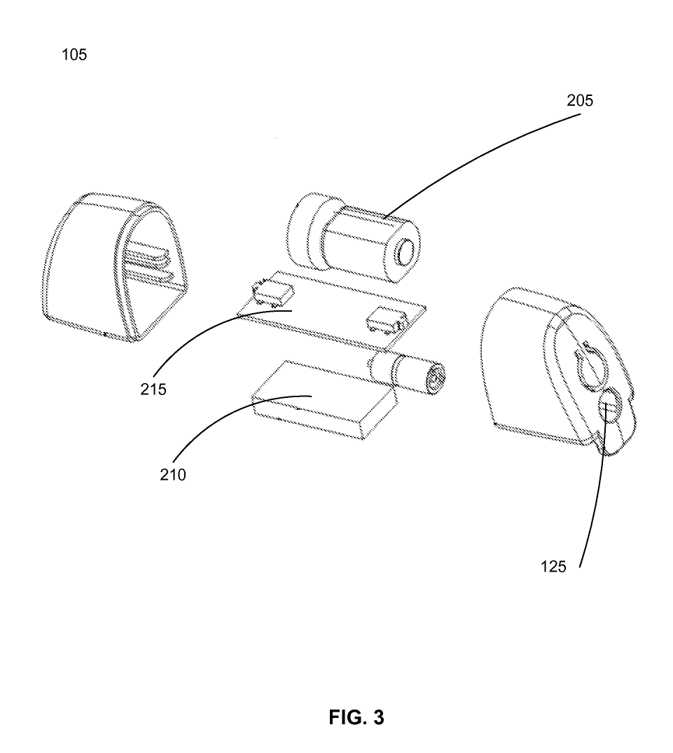

FIG. 3 is an exploded diagram of one embodiment of the body of the massager. FIG. 3 illustrated that the body 105 of the massager 100 includes the vibrating motor 205, the controller 215, the power source 210, and the power connecting interface 125. As described in above in conjunction with FIG. 2, the power connecting interface 125 is electrically coupled to the power source 210. In one example, the power source 210 is a lithium-ion battery. The power source 210 is in turn electrically coupled to the vibrating motor 205 and powers the vibrating motor 205. The controller 215 causes the vibrating motor 205 to implement one or more operation modes that include vibrations that vibrate the body 105 of the massager 100.

While various embodiments have been described above, it should be understood that they have been presented by way of example only, and not limitation. For example, any of the components may employ any of the desired functionality set forth hereinabove. The functions can be distributed differently across the components or different functions can be combined into one component. The massager can be designed to have a variety of different shapes and sizes, and the embodiments shown herein are simply examples of some such shapes and sizes. The internal components of the massager can vary, and can include fewer or more components that those shown here. Thus, the breadth and scope of a preferred embodiment should not be limited by any of the above-described exemplary embodiments.

What is claimed is:

1. A massager, comprising:
a body comprising a vibrating motor and a circular hole, the circular hole configured for insertion by a penis, the vibrating motor configured to vibrate the body during operation; and
a male genital projection, protruding from the body, configured to abut a length of the penis and to transmit vibrations generated by the vibrating motor, the male genital projection structured for insertion simultaneously with the penis into a vagina.

2. The massager of claim 1, wherein the male genital projection is structured to partially cover a portion of a surface of the penis.

3. The massager of claim 1, wherein a portion of the male genital projection is structured to abut a clitoris when inserted into the vagina.

4. The massager of claim 3, wherein the portion of the male genital projection abutting the clitoris is configured to vibrate when the massager is configured into a first operating mode.

5. The massager of claim 4, wherein a portion of the male genital projection is structured to abut a G-spot when inserted into the vagina.

6. The massager of claim 5, wherein the portion of the male genital projection abutting the G-spot is configured to vibrate when the massager is configured into a second operating mode.

7. The massager of claim 1, wherein the vibrations generated by the vibrating motor comprise one of a selectable plurality of vibration patterns.

8. The massager of claim 1, wherein the body is made of silica gel.

9. The massager of claim 1, wherein the circular hole is elastic and is structured to be secured onto the penis.

10. The massager of claim 1, wherein the body further comprises a charging interface for charging the massager.

11. A massager, comprising:
a base comprising a vibrating motor configured to vibrate in one of one or more operating modes;
a coupling means coupled to the base and configured to couple the massager to a penis of a user; and
a projection coupled to and extending outward from the base, the projection configured to abut a portion of a surface of the penis when the massager is coupled to the penis.

12. The massager of claim 11, wherein the projection is structured to partially cover a portion of a surface of the penis.

13. The massager of claim 11, wherein a portion of the projection is structured to abut a clitoris when inserted into the vagina.

14. The massager of claim 13, wherein the portion of the projection abutting the clitoris is configured to vibrate when the massager is configured into a first operating mode.

15. The massager of claim 14, wherein a portion of the projection is structured to abut a G-spot when inserted into the vagina.

16. The massager of claim 15, wherein the portion of the projection abutting the G-spot is configured to vibrate when the massager is configured into a second operating mode.

17. The massager of claim 11, wherein the vibrations generated by the vibrating motor comprise one of a selectable plurality of vibration patterns.

18. The massager of claim 11, wherein the base is made of silica gel.

19. The massager of claim 11, wherein the coupling means is elastic and is structured to be secured onto the penis.

20. The massager of claim 11, wherein the base further comprises a charging interface for charging the massager.
